(19) United States
(12) Patent Application Publication
(10) Pub. No.: US 2014/0058976 A1
(43) Pub. Date: Feb. 27, 2014

(54) COMPUTERIZED SALES TOOL FOR VISUALIZING THE IMPACT OF SELECTIVE FINANCIAL PRODUCTS ON RETIREMENT PLANNING

(71) Applicant: THE LINCOLN NATIONAL LIFE INSURANCE COMPANY, Fort Wayne, IN (US)

(72) Inventors: DAVID GOODRICH, Garnet Valley, PA (US); CARI NICHOLAS MACKAY, Denver, CO (US); ROBERT C. LEWIS, Bridgeville, PA (US); ROBINDER PAL, Chester Springs, PA (US)

(21) Appl. No.: 13/970,154

(22) Filed: Aug. 19, 2013

Related U.S. Application Data
(60) Provisional application No. 61/692,990, filed on Aug. 24, 2012.

(51) Int. Cl. G06Q 40/06

(52) U.S. Cl. CPC G06Q 40/06
USPC 705/36 R

(57) ABSTRACT

A computerized financial product sales system is disclosed. The system includes a customer profile calibration module, a product selection module, and a visualization module. The customer profile calibration module may be configured to allow selection of one or more customer parameters. The product selection module may be configured to allow selection of a financial product. The visualization module may be configured to graphically display an impact of the selected financial product on one or more of the selected customer parameters based on actual historical data over a specified time period.

### RELATED APPLICATIONS

This application claims the benefit of U.S. Provisional Application Ser. No. 61/692,990 filed Aug. 24, 2012, for a “Computerized Sales Tool for Visualizing the Impact of Selective Financial Products on Retirement Planning,” which is hereby incorporated by reference in its entirety.

### FIELD OF THE INVENTION

The present invention relates generally to computerized systems and methods for assisting in the sale of financial products and, more particularly, to a computer-based tool for visualizing the impact of selective financial products on retirement planning in a sales demonstration.

### BACKGROUND AND SUMMARY OF THE INVENTION

Computer-based retirement planning systems and methods have been available to financial planners, investment managers, and individuals for some time. Previously available software systems and tools include sophisticated programs which consider various types of retirement income sources, projections of retirement expenses, and other factors. These systems are available as free standing applications for use on individual computers, and in online versions which can be accessed by numerous computer users.

With existing retirement planning systems, users generally provide comprehensive information as part of creating a retirement plan. Gathering this comprehensive information about the user tends to be time intensive, but this detailed and comprehensive approach is important for adequate planning to assure the availability of sufficient resources for retirement. Notwithstanding advantages of spending adequate time to create a detailed retirement plan using one of these sophisticated computer systems, a different approach is necessary in a sales demonstration. In a sales environment, the potential customer will likely not have the patience for salespersons spending significant time gathering information. There exists a need for a sales demonstration tool that quickly shows the positive impact of various financial products offered for sale in a manner the potential customer can easily understand.

One aspect to the present invention is a computer-based sales tool for financial products that has features which are not available from existing financial planning tools. In its preferred embodiments, the tool is intended for use by financial advisors and other professionals who assist individual customers in planning activities. The sales tool allows these professionals to more easily explain differences among financial products, such as tax efficiency, income preservation, guaranteed income, etc., to a client. Typically, the sales tool is configured to visually illustrate the impact of actual financial products offered by insurance companies, investment houses or other institutions in the financial services industry based on actual data, such as historical rate of returns, actuarial data, and/or product/rider specific tables. This means that differentiating features of proprietary financial products can be visualized by the client, thereby showing the impact and potential value of these features. The sales tool's ability to model actual products with proprietary features is a key distinction from existing financial calculators that use “textbook” or “vanilla” products to make projections.

According to another aspect, this disclosure provides a computerized system. The computerized system may include a customer profile calibration module, a product selection module, and a visualization module in some embodiments. The customer profile calibration module may be configured to allow selection of one or more customer parameters. The product selection module may be configured to allow selection of a financial product. The visualization module may be configured to graphically display an impact of the selected financial product on one or more of the selected customer parameters based on actual historical data over a specified time period.

The customer profile calibration module may be further configured to allow an adjustment of the one or more of the selected customer parameters and the specified time period. The visualization module may be further configured to automatically display an adjusted impact of the selected financial product on the selected one or more customer parameters, based on one or more adjusted customer parameters.

According to a further aspect, this disclosure provides a computerized system including one or more computing devices that include a memory and a processor. The memory has program code stored therein. The processor may be in communication with the memory, and may carry out instructions in accordance with the stored program code, wherein the program code, when executed by the processor, causes the processor to perform operations comprising: allowing selection of one or more customer parameters; allowing selection of a financial product; and graphically displaying an impact of the selected financial product on one or more of the selected customer parameters based on actual historical data over a specified time period.

According to yet a further aspect, the disclosure provides a computerized system including a memory having program code thereon. The memory has machine-executable code stored thereon that causes a processor to generate a user interface on a display, such as on a touch screen display. In embodiments using a touch screen display, a plurality of profile interface elements may be provided and at least one product interface element. Each of the plurality of profile interface elements may be associated with a respective profile parameter. The at least one product interface element may be associated with a financial product. When the code executes, it may cause the processor to: receive a selection of one of the plurality of profile interface elements to select the respective profile parameter; receive a selection of the at least one product interface element to select the financial product; and, in response to a user selecting an interface element, graphically display an impact of the selected financial product on the plurality of customer profile parameters based on actual historical data over a specified time period.

Certain embodiments of the sales tool do not require a comprehensive data gathering approach; instead, the sales tool allows a client to understand the impact of various financial products using minimal information inputted into the system. The input parameters can be easily varied to perform interactive “what if” scenarios. For example, the client could adjust the retirement age or annuity funding amount and immediately visualize the impact in asset base or future income stream. This allows the client to identify potential short falls in expected income, and see the impact of actual financial products in response to the projected short falls. Embodiments of the sales tool could be used to model a range of financial products, including annuities, long term care insurance, and life insurance.

Additional features and advantages of the subject system and method will become apparent to those skilled in the art upon consideration of the following detailed materials which form part of this provisional application.

### BRIEF DESCRIPTION OF THE DRAWINGS

The present disclosure will be described hereafter with reference to the attached drawings which are given as non-limiting examples only, in which:

FIG. 1 is a diagrammatic view of an example machine on which various methods of the sales tool discussed herein can be executed.

FIG. 2 is a diagrammatic view of an embodiment in which the sales tool is accessible over a network.

FIG. 3 is a diagrammatic view of various modules that could be included in the sales tool according to one embodiment.

FIGS. 4-29 are screenshots illustrating certain portions of the sales tool with an example graphical user interface according to one embodiment.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

This disclosure relates generally to a computerized system and method for graphically or visually showing the impact of selective financial products being offered in a sales demonstration. During a sales demonstration, it is desirable to quickly show the potential impact of financial products being offered on retirement planning with relatively small amount of input data needing to be entered about the potential customer. In one aspect, this disclosure provides a computerized tool that allows potential customers to immediately visualize the potential impact of financial products being offered on retirement planning, such as increased retirement income or assets, based on historical performance of the actual products being offered. Rather than a using a comprehensive set of parameters regarding the individual's financial health and retirement goals, which could take a substantial time to input, one embodiment of the tool allows a small number of parameters to be inputted. These parameters could be easily changed so the customer can quickly perform “what if” scenarios as to potential impacts of the parameters on retirement planning. The graphical representation allows the potential customer to focus attention on potential gaps that may exist without having the financial products being offered, thereby quickly showing the value of these products in a manner the customer can easily understand. Although the sales tool will be generally discussed below with regard to showing the impact of various annuity products offered for sale, embodiments are also contemplated in which the sales tool could be used to show the impact of various other financial products, such as long term care products and life insurance products offered for sale.

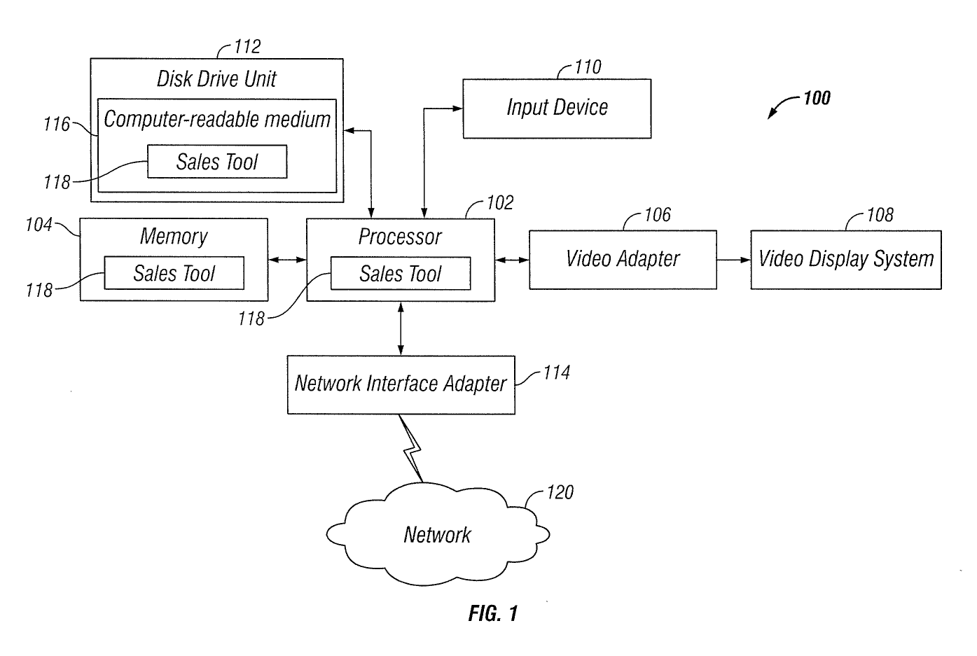

FIG. 1 illustrates a diagrammatic representation of a machine 100 in the example form of a computer system that may be programmed with a set of instructions to perform any one or more of the methods discussed herein. The machine may be a personal computer, a notebook computer, a server, a tablet computer, a personal digital assistant (“PDA”), a cellular telephone, or any machine capable of executing a set of instructions (sequential or otherwise) that specify actions to be taken by that machine.

The machine 100 may operate as a standalone device or may be connected (e.g., networked) to other machines. In embodiments where the machine is a standalone device, the set of instructions could be a computer program stored locally on the device that, when executed, causes the device to perform one or more of the methods discussed herein. Consider an example in which the machine 100 is a tablet device, such as an iPad™ or Android™ device; the computer program could be an “app” installed on the tablet device. In embodiments where the computer program is locally stored, data may be retrieved from local storage or from a remote location via a network. For example, historical data regarding various financial products could be stored locally on the machine or could be accessed remotely if a network connection is available. In a networked deployment, the machine 100 may operate in the capacity of a server or a client machine in server-client network environment, or as a peer machine in a peer-to-peer (or distributed) network environment. Although only a single machine is illustrated in FIG. 1, the term “machine” shall also be taken to include any collection of machines that individually or jointly execute a set (or multiple sets) of instructions to perform any one or more of the methods discussed herein.

The example machine 100 illustrated in FIG. 1 includes a processor 102 (e.g., a central processing unit (“CPU”)), a memory 104, a video adapter 106 that drives a video display system 108 (e.g., a liquid crystal display (“LCD”) or a cathode ray tube (“CRT”)), an input device 110 (e.g., a keyboard, mouse, touch screen display, etc.) for the user to interact with the program, a disk drive unit 112, and a network interface adapter 114. Note that various embodiments of the machine 100 will not always include all of these peripheral devices.

The disk drive unit 112 includes a computer-readable medium 116 on which is stored one or more sets of computer instructions and data structures embodying or utilized by a sales tool 118 described herein. The computer instructions and data structures may also reside, completely or at least partially, within the memory 104 and/or within the processor 102 during execution thereof by the machine 100; accordingly, the memory 104 and the processor 102 also constitute computer-readable media. Embodiments are contemplated in which the sales tool 118 may be transmitted or received over a network 120 via the network interface device 114 utilizing any one of a number of transfer protocols including but not limited to the hypertext transfer protocol (“HTTP”) and file transfer protocol (“FTP”).

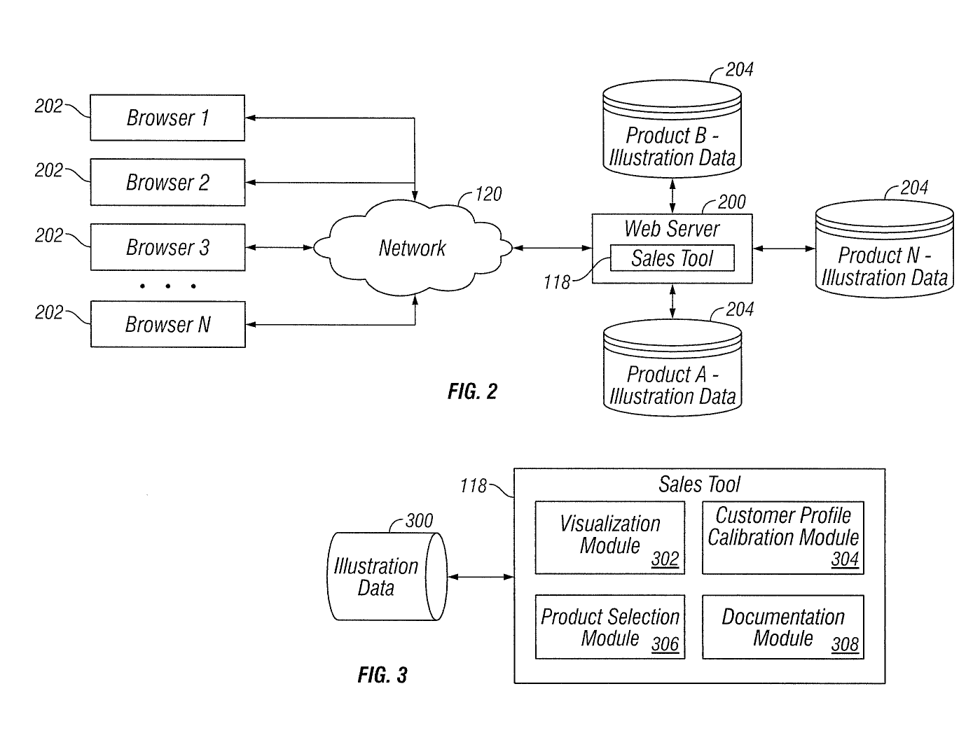

The network 120 may be any type of communication scheme including but not limited to fiber optic, cellular, wired, and/or wireless communication capability in any of a plurality of protocols, such as TCP/IP, Ethernet, WAP, IEEE 802.11, or any other protocol. For example, as shown in FIG. 2, the sales tool 118 could be accessed from a web server 200 via the network 120 using a browser program 202, such as Internet Explorer™ by Microsoft Corporation of Redmond, Wash., or Safari™ by Apple Corp. of Cupertino, Calif. In the example shown in FIG. 2, the web server 200 is in communication with illustration data 204 for products offered for sale that could be visualized based on parameters entered into the sales tool 118. In some embodiments, the web server 200 could be in communication with administrative systems, such as illustration systems, to receive available illustration data for various products.

While the computer-readable medium 116 shown in the example embodiment of FIG. 1 is a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing a set of instructions for execution by the machine and that cause the machine to perform any one or more of the methods described herein, or that is capable of storing data structures utilized by or associated with such a set of instructions. The term “computer-readable medium” shall accordingly be taken to include, but not be limited to, solid-state memories, optical media, flash memory, and magnetic media.

FIG. 3 is a block diagram showing an embodiment with various modules that may be included in the sales tool 118. In the embodiment shown, the sales tool 118 includes financial product illustration data 300, a visualization module 302, a customer profile calibration module 304, a product selection module 306, and a documentation module 308. For the purposes of this specification, the term “module” includes an identifiable portion of computer code, computational or executable instructions, data, or computational object to achieve a particular function, operation, processing, or procedure. A module may be implemented in software, hardware/circuitry, or a combination of software and hardware. An identified module of executable code, for example, may comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code could be a single instruction, or many instructions, and may even be distributed over several different code segments, among different programs, and across several memory devices. Similarly, modules representing data may be embodied in any suitable form and organized within any suitable type of data structure. The data may be collected as a single data set, or may be distributed over different locations including over different storage devices.

The financial product illustration data 300 provides, in one embodiment, historical performance data regarding one or more actual financial products, such as annuity products. The use of historical data for actual financial products in this embodiment allows the customer to visualize product feature differentiators of specific products, which may include proprietary features, and understand the value of these products versus a generic financial product. For example, the performance data of the financial products could be provided for each customer profile parameter that could be selected. In such an embodiment, there would be no need to calculate the potential performance of a hypothetical financial product based on actuarial formulas. Instead, the parameters selected for the customer profile could, in essence, control pointers in the appropriate tables corresponding with historical data based on an actual product.

Consider an example in which a data set for a product includes historical data for a number of years. In this example, certain of the customer profile parameters are an annuity investment amount set to $600,000, a current age of 67 and an income start age of 69. With this information, the historical data for an annuity product could be selected and visualized, which will track the actual performance of the selected annuity for a historical time period. If the historical data were for the period from 1987 to 2007, for example, the performance of an actual product starting in 1987 could be used. If the parameter for income start age was changed to 72, the pointers to the historical data would also change to correspond to the historical data in which income is delayed by three years. Since the historical data is discrete information instead of calculated data, in this embodiment, this provides information about actual products for the customer to consider.

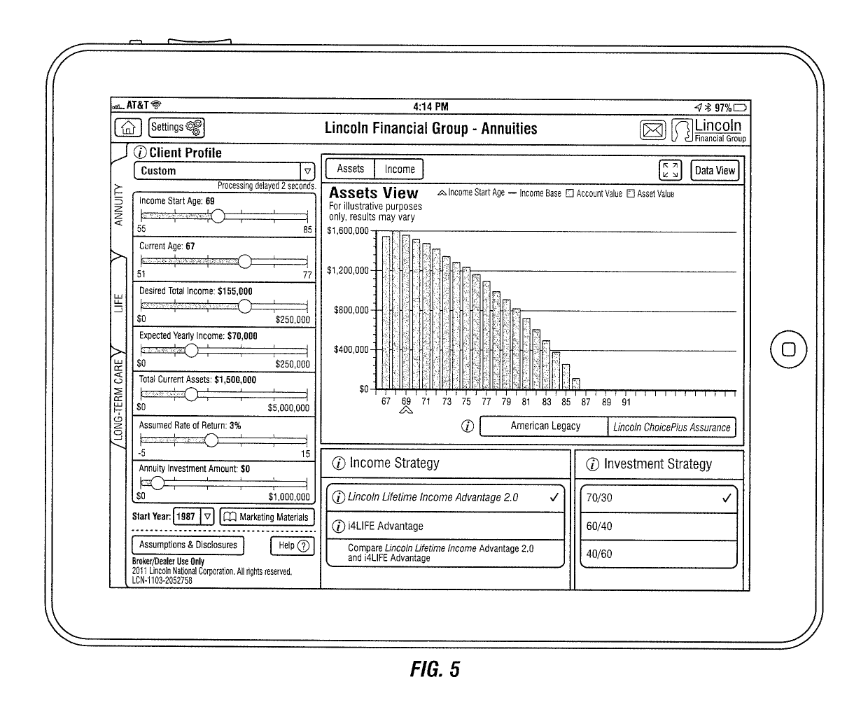

The visualization module 302 is configured to graphically represent the impact of a selected financial product on a retirement plan, such as an amount of income or assets, over a time period based on historical data. The visualization module 302 graphically displays this information based on parameters provided by the customer profile calibration module 304, which is described in more detail below. For example, the graphical display of assets or income will change based on various parameters, such as current age, income start age, total assets, etc., selected for a scenario. As the customer or financial professional adjusts these parameters, the visualization module 302 updates the graph based on the parameters. For example, the customer could quickly determine how much income various retirement strategies might provide in an easily understandable visual format by simply changing a few input parameters. This provides immediate feedback for the customer as to various financial products being offered to show the value of these products and thereby potentially increase sales. FIGS. 5 to 13 show various example graphs that could be generated by the visualization module 302 based on parameters provided by the customer profile calibration module 304.

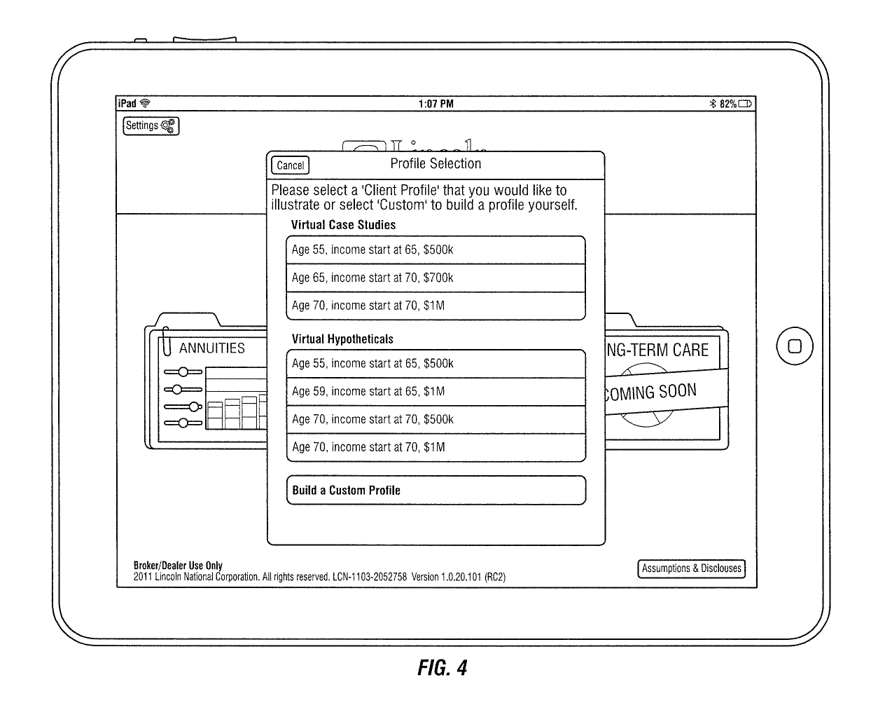

The customer profile calibration module 304 is configured to allow selection of a predetermined customer profile and/or create a custom customer profile by adjusting various parameters concerning the customer, such as demographic and financial information. As discussed below, FIG. 4 is a screen shot showing an example manner by which the customer profile could be selected and FIG. 5 shows an example interface for adjusting these parameters.

The product selection module 306 allows the user to select between various financial products, which results in the historical performance of the selected product to be graphed for the user based on the selected parameters. FIG. 5 shows an example interface from which the user could select between financial products. In this example, the user may select an “Income Strategy” based on two actual products on the market—“Lincoln Lifetime Income Advantage 2.0” or “i4Life Advantage.” The user in this example can also choose an “Investment Strategy.” When the user makes a selection, this sets the product for which illustration data 300 should be used based on the parameters selected using the customer profile calibration module 304. Accordingly, the customer can compare the potential results of actual products on the market (compared to a hypothetical product) based on historical data of those products. In the example shown in FIG. 5, the user can also select the “start year” to be used for the historical data, which is set to “1987” in the example shown.

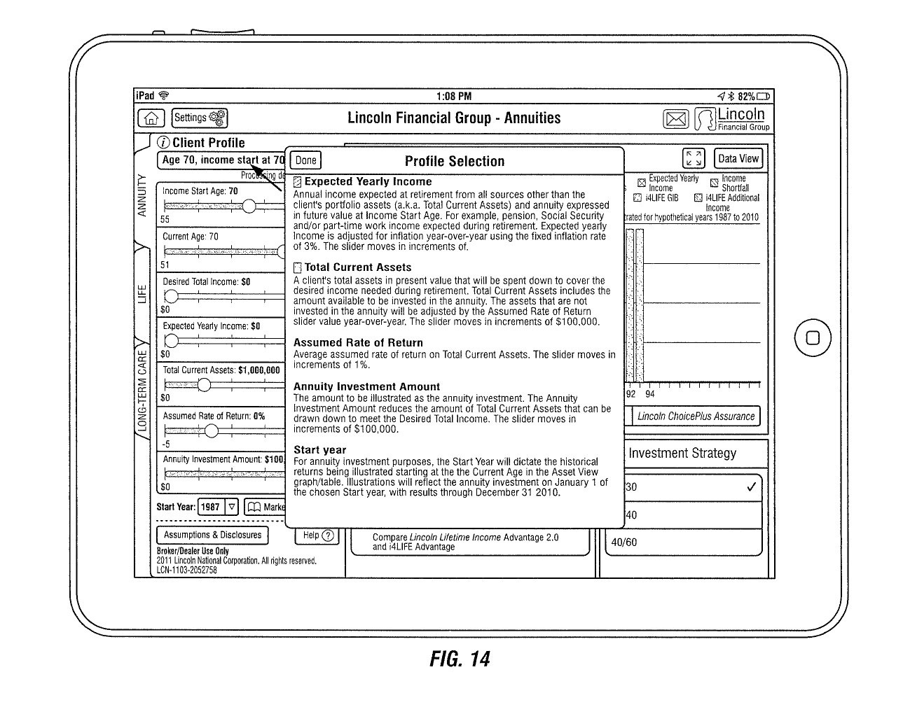

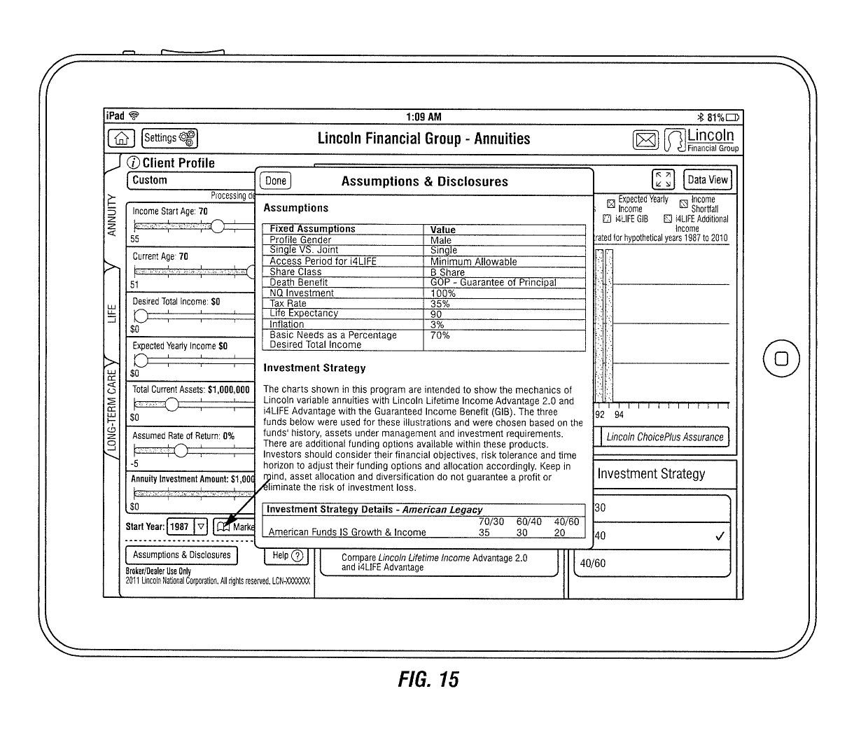

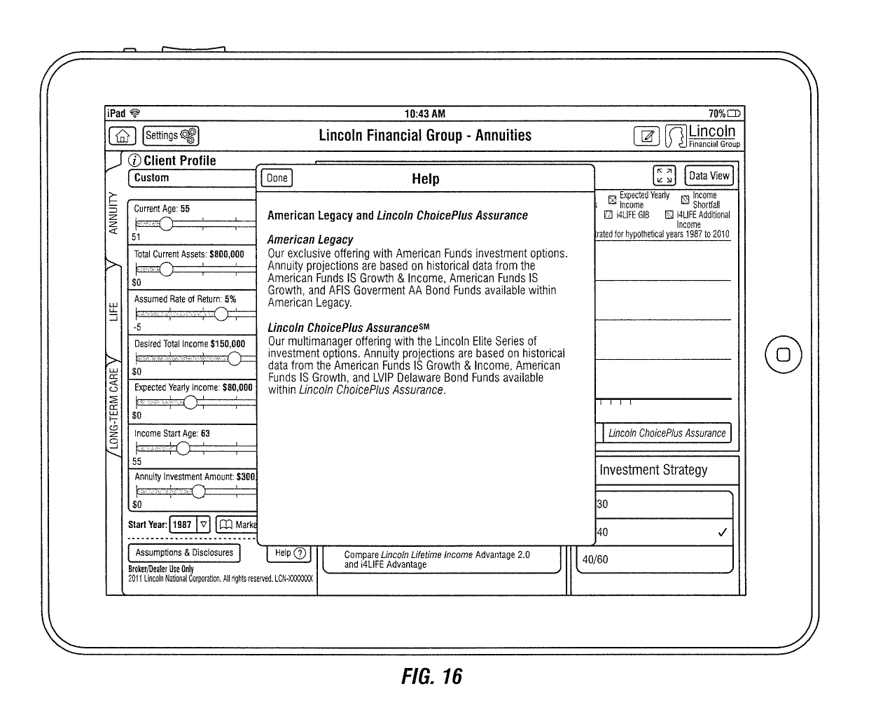

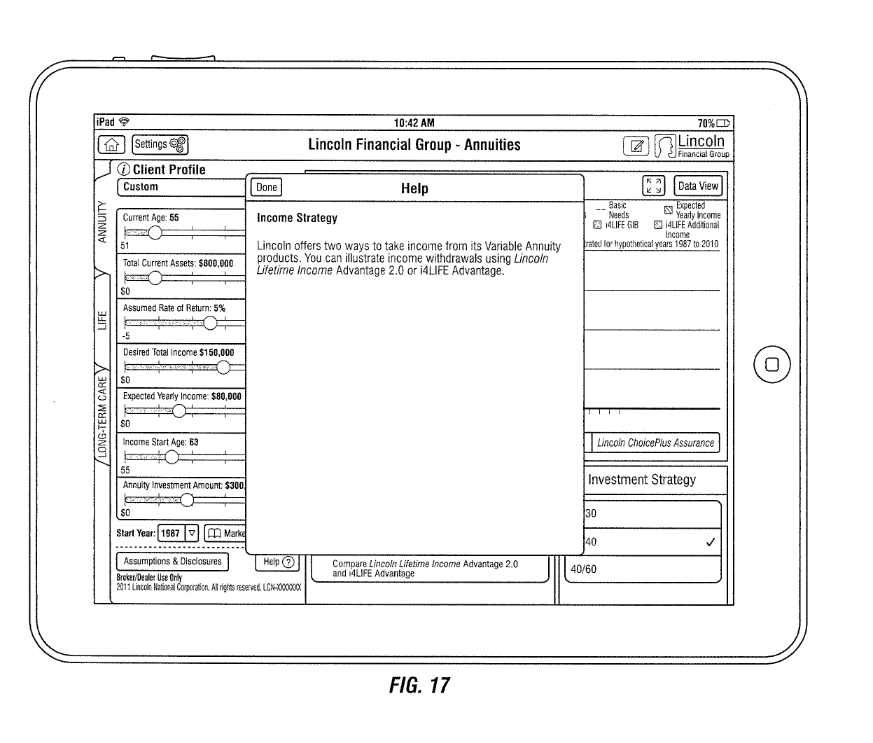

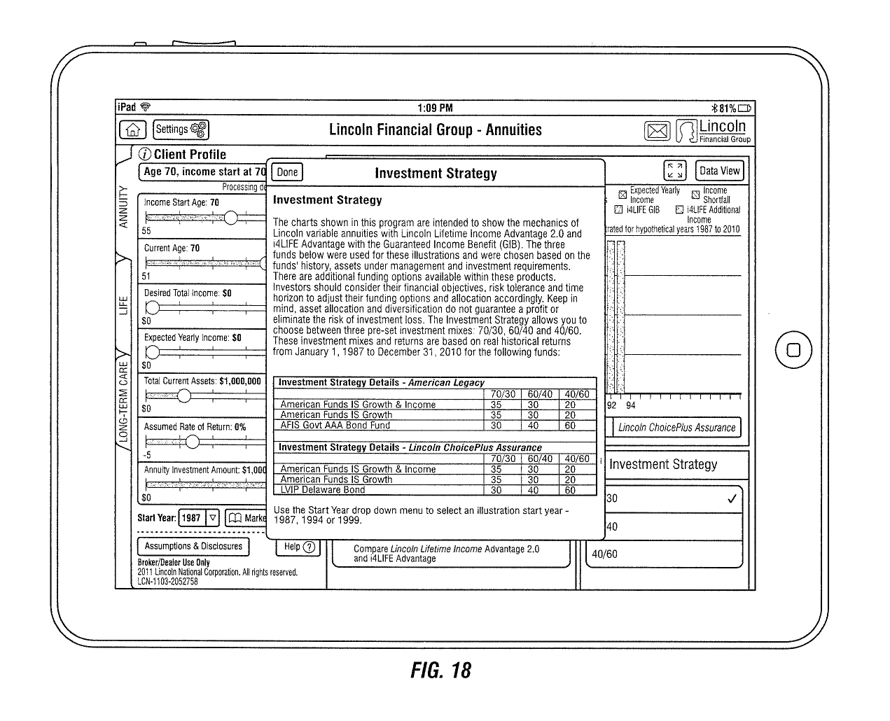

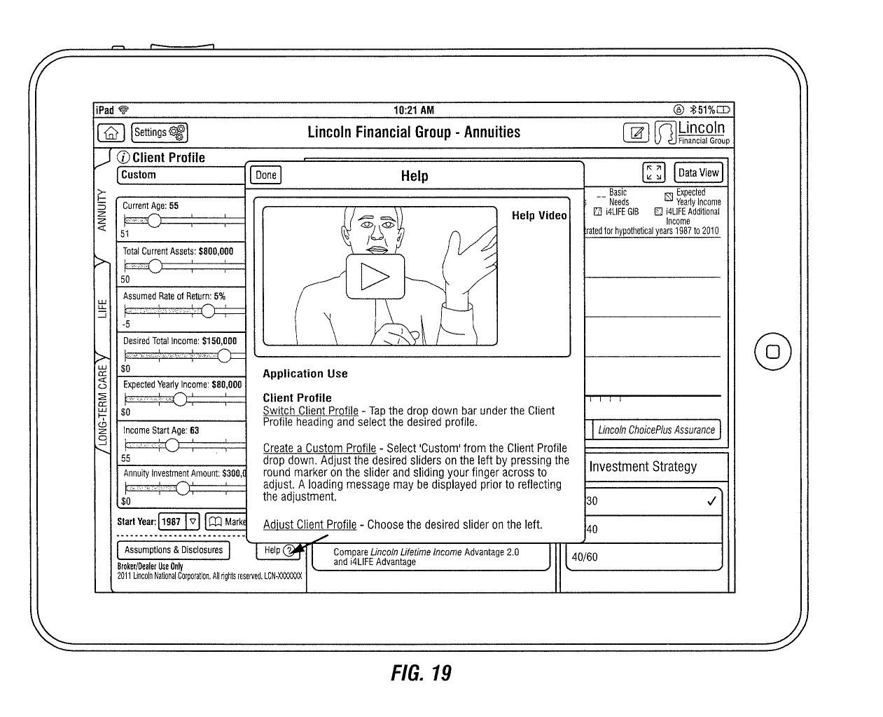

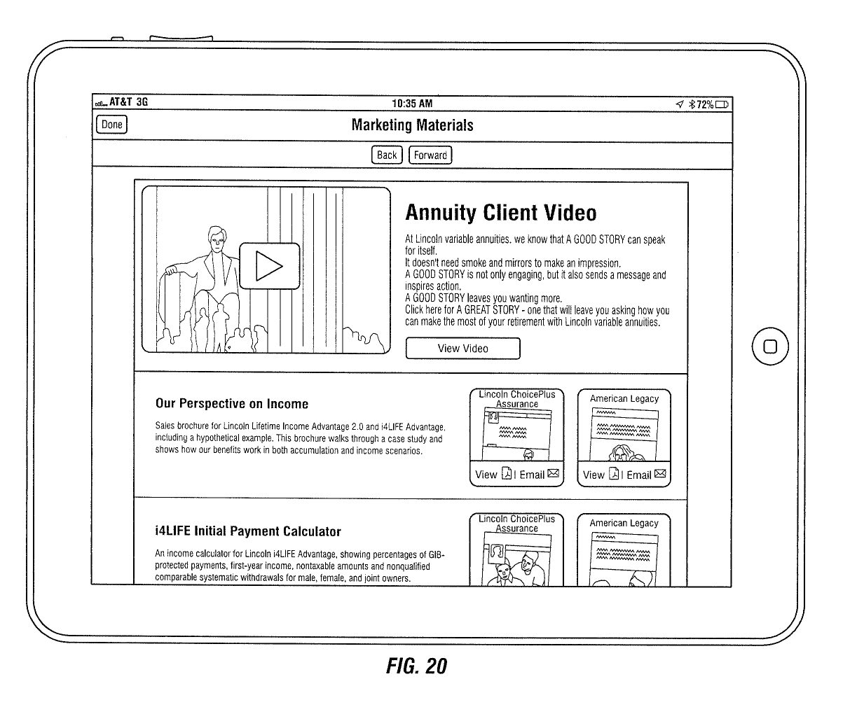

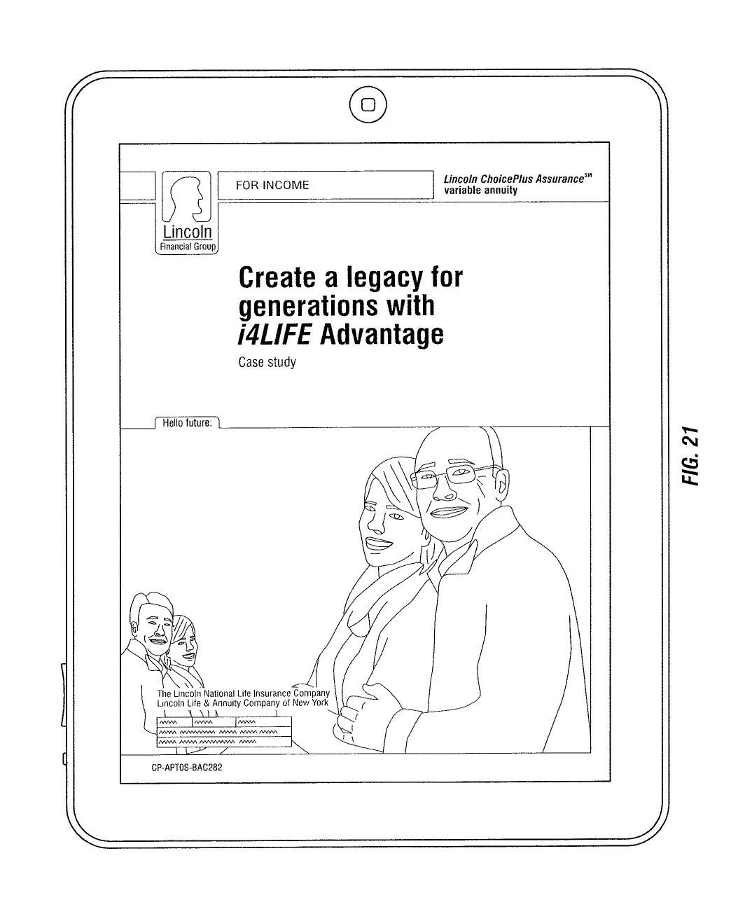

The documentation module 308 is configured to allow selection of documentation, such as marketing material and assumptions, regarding the products that can chosen using the product selection module 306 and possibly other related information. For example, marketing materials regarding the products may be stored on the machine 100 or could be remotely accessible. This could include brochures, multimedia presentations, such as videos, and other materials. In some cases, the documentation module 308 could be configured to send this information to an electronic address, such as an email address. Embodiments are contemplated in which screenshots from the scenarios could also be electronically communicated to an electronic address. FIGS. 14-21 show information that could be provided by the documentation module 308.

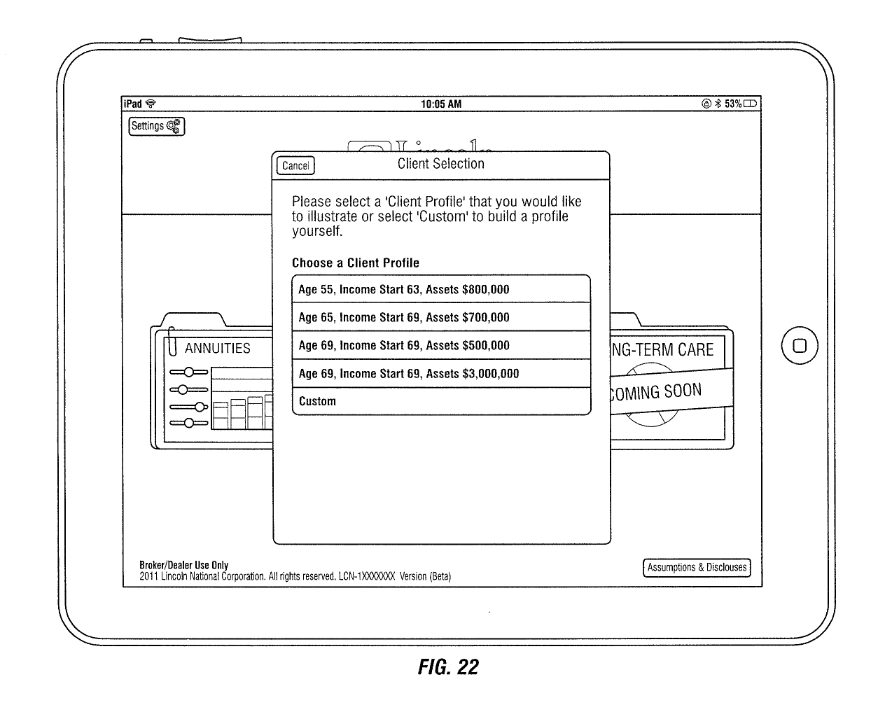

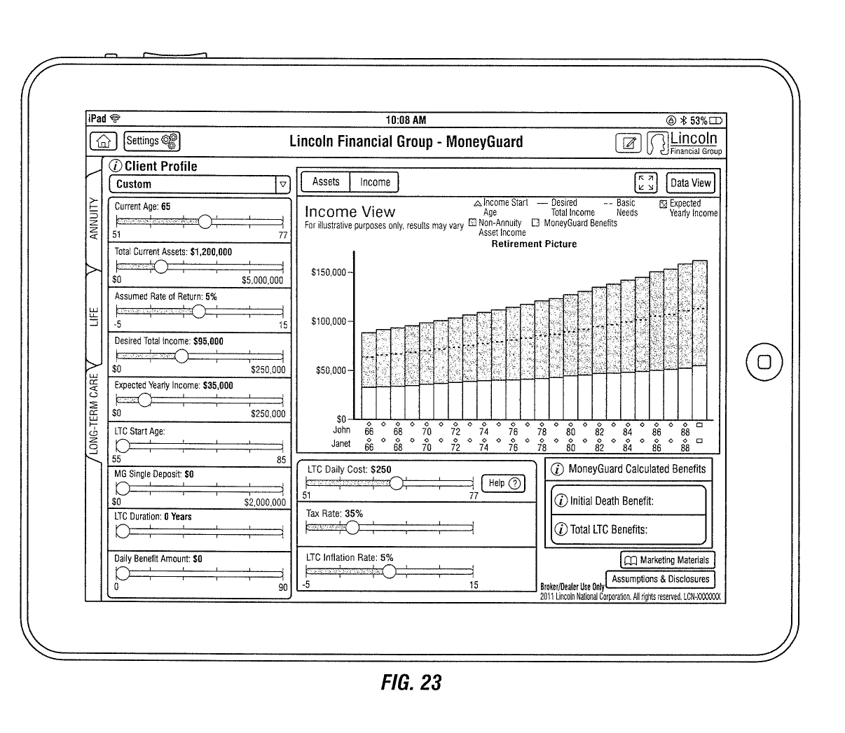

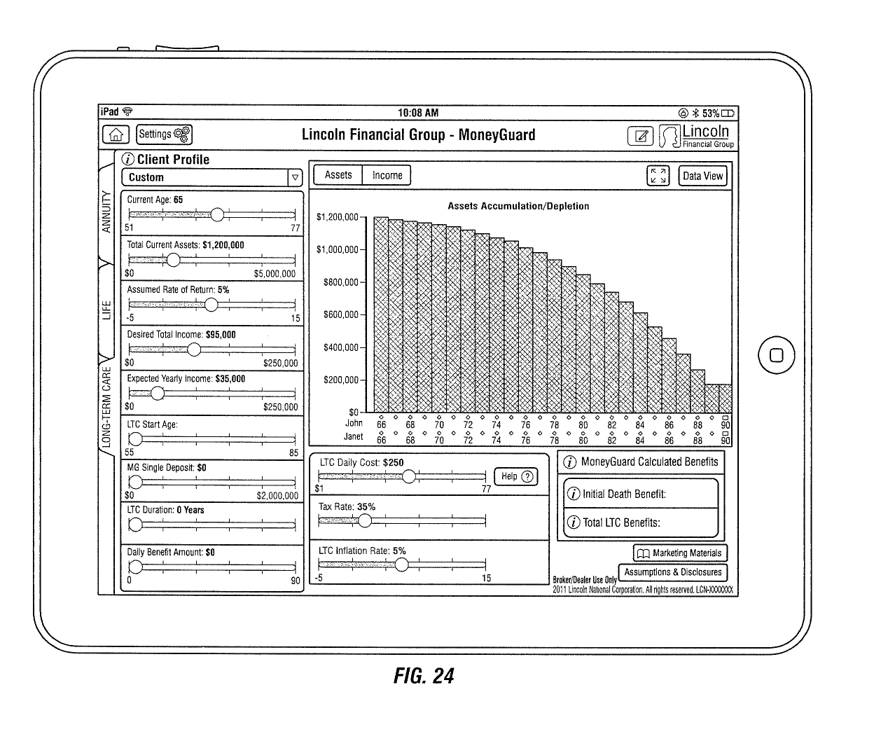

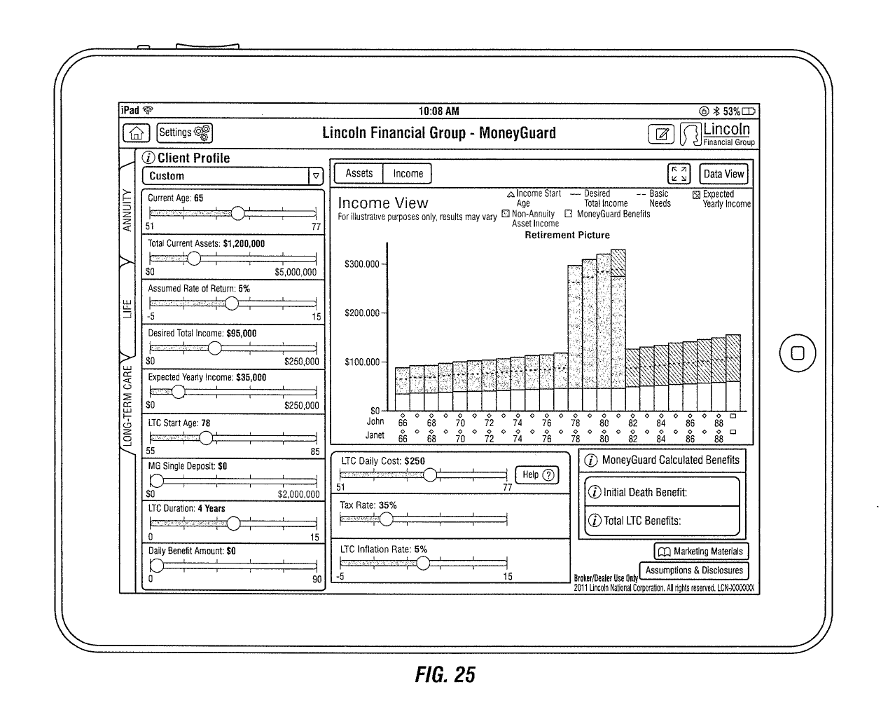

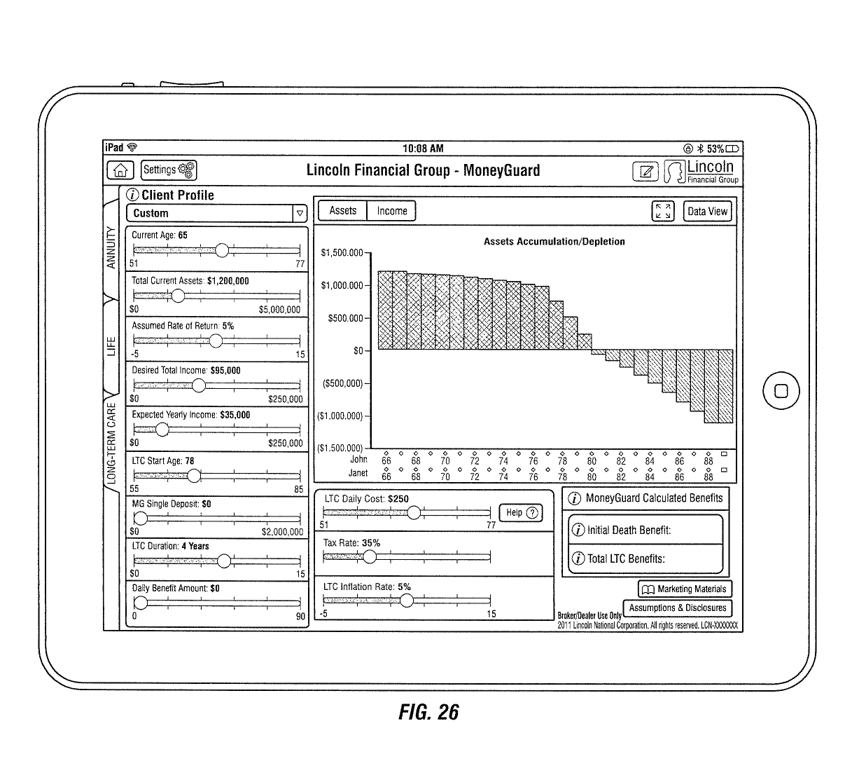

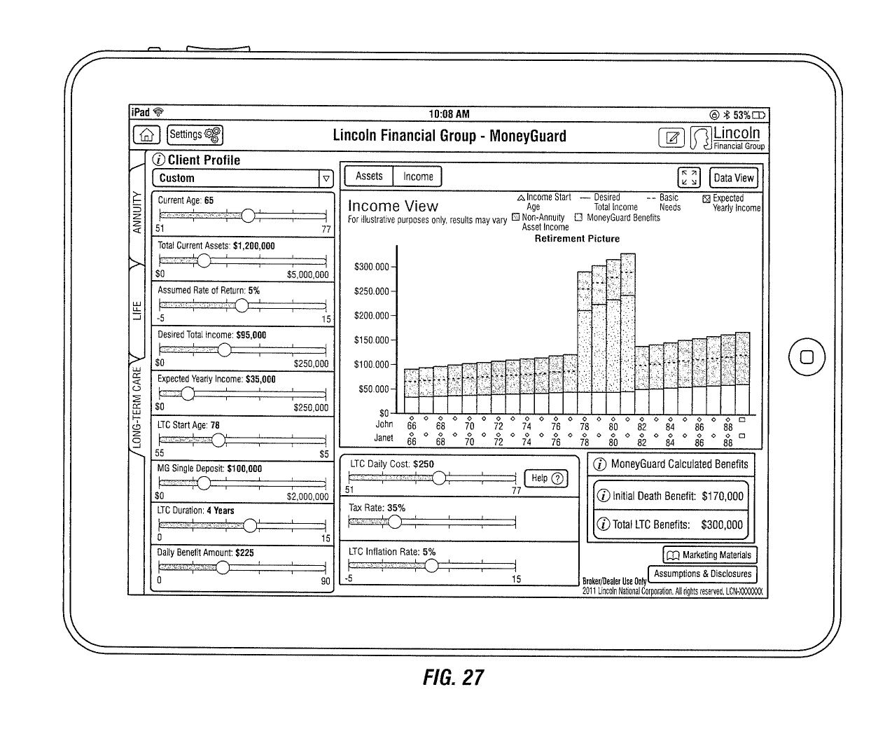

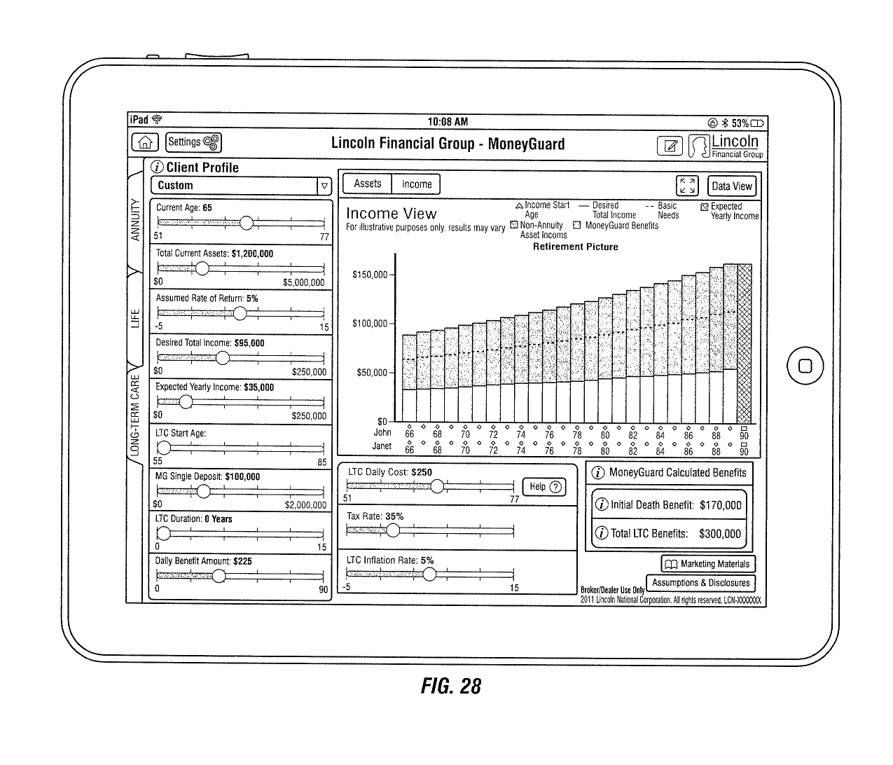

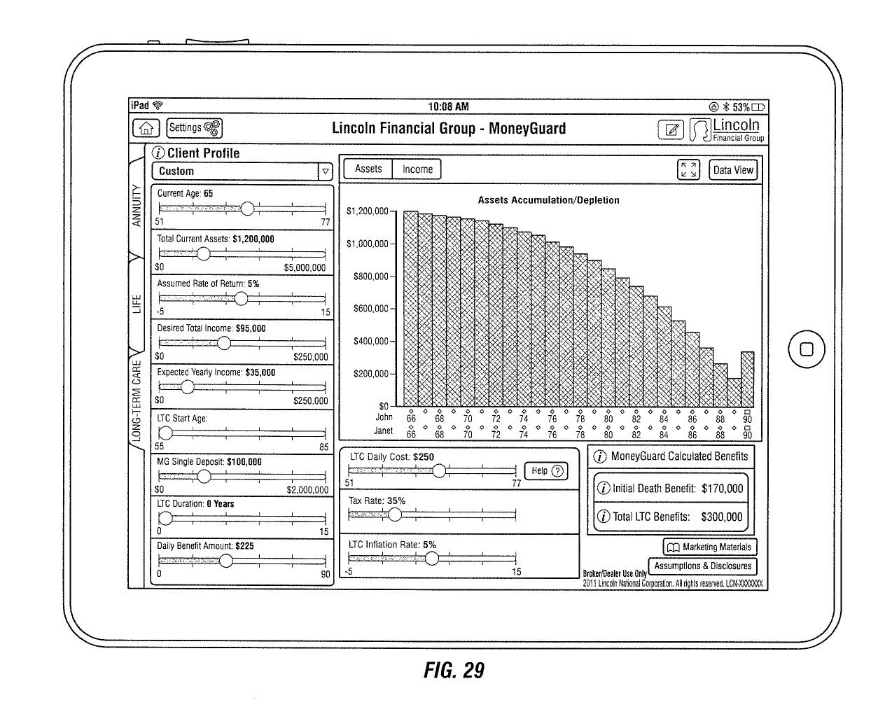

FIGS. 4-21 are example screen shots showing an embodiment of the sales tool 118 with regards to a sales demonstration for an annuity product. FIGS. 22-29 are example screen shots showing an embodiment of the sales tool 118 with regards to a sales demonstration for a long term care insurance product. These interfaces are shown for example purposes only and are not intended to limit the scope of the sales tool 118.

FIG. 4 is an example screen shot showing the selection of an initial customer profile from which a graphical visualization of a retirement plan can be seen. In the embodiment shown, the user may select from a plurality of predetermined customer parameters. This example also allows the user to build a customer profile by selecting among a plurality of possible parameters. The selection of the customer parameters sets the initial visualization of the retirement timeline, such as the income and asset graphs. In this example, the user may select from several predetermined profiles, such as a predetermined profile in which the customer's current age is 55, the desired income start date is 65 and they have $500,000 in assets. One skilled in the art should appreciate that numerous variations of predetermined customer profiles are possible. The user could also select to “Build a Custom Profile” in this example. If this is selected, the user may adjust these parameters, such as using an interface like is shown in FIG. 5.

FIG. 5 is an example screen shot showing an interface from which the user can visualize financial information of a retirement plan based on a plurality of parameters set by the user. In this example interface, the user may adjust the positions of sliders to select a desired income start age, current age, desired total income, expected yearly income, total current assets, assumed rate of return, and annuity investment amount. As the positions of the sliders in this example are moved based on various “what if” scenarios, the visualization module 302 updates the graph. One skilled in the art should appreciate that other interface elements may be used to enter these parameters. One key aspect of the customer profile selection module is the small number of parameters that are needed to visually represent the retirement plan. Unlike existing financial planning software that requires exhaustive information, the sales tool 118 is not intended for comprehensive retirement planning, but to quickly show the impact of various financial products in a sales demonstration. Likewise, the customer may visualize different scenarios in an iterative fashion by adjusting one or more of the profile parameters.

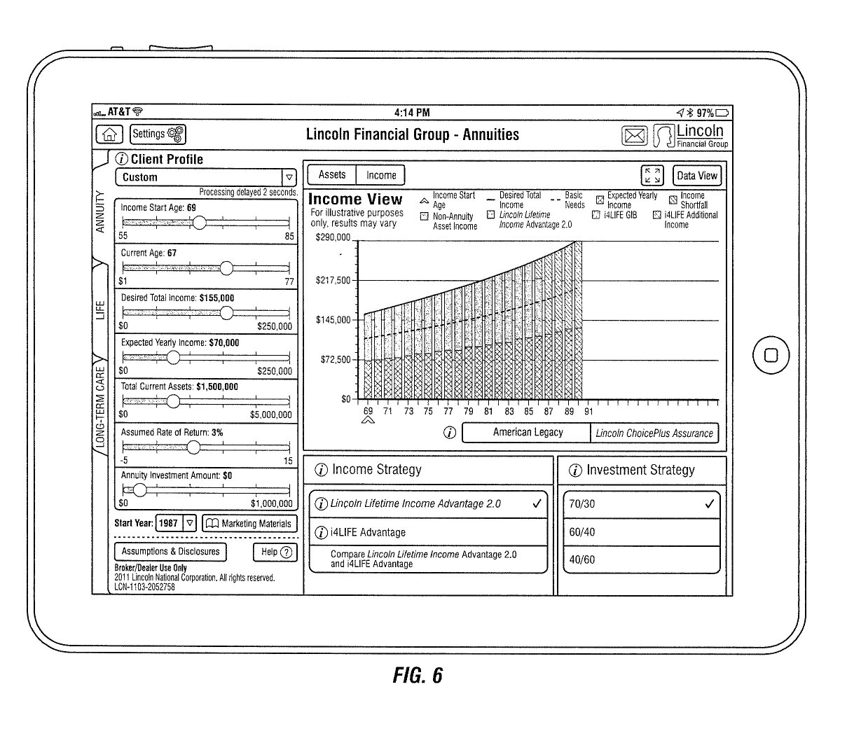

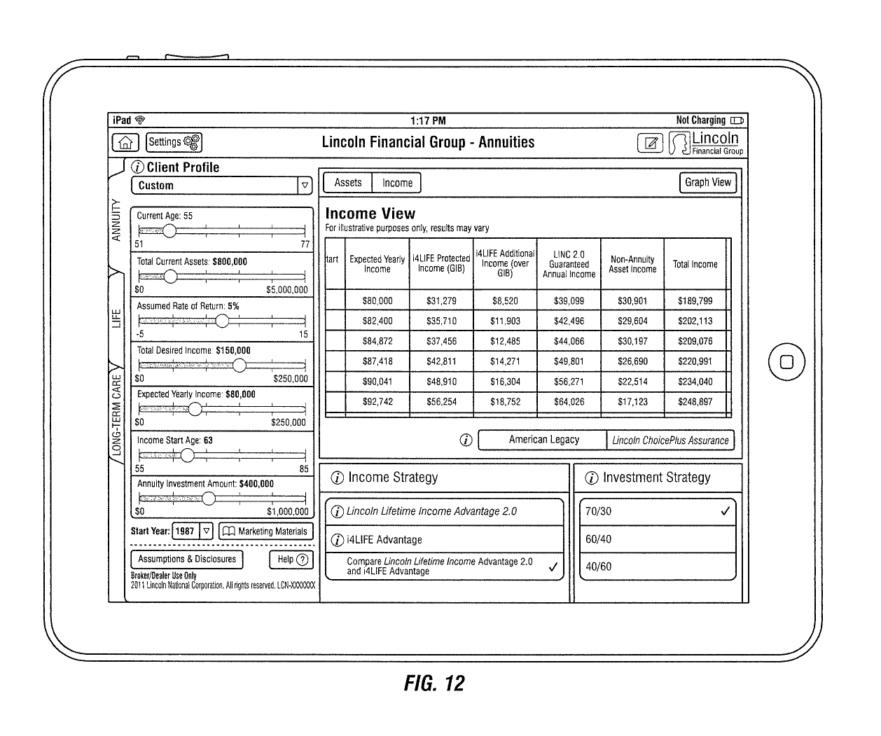

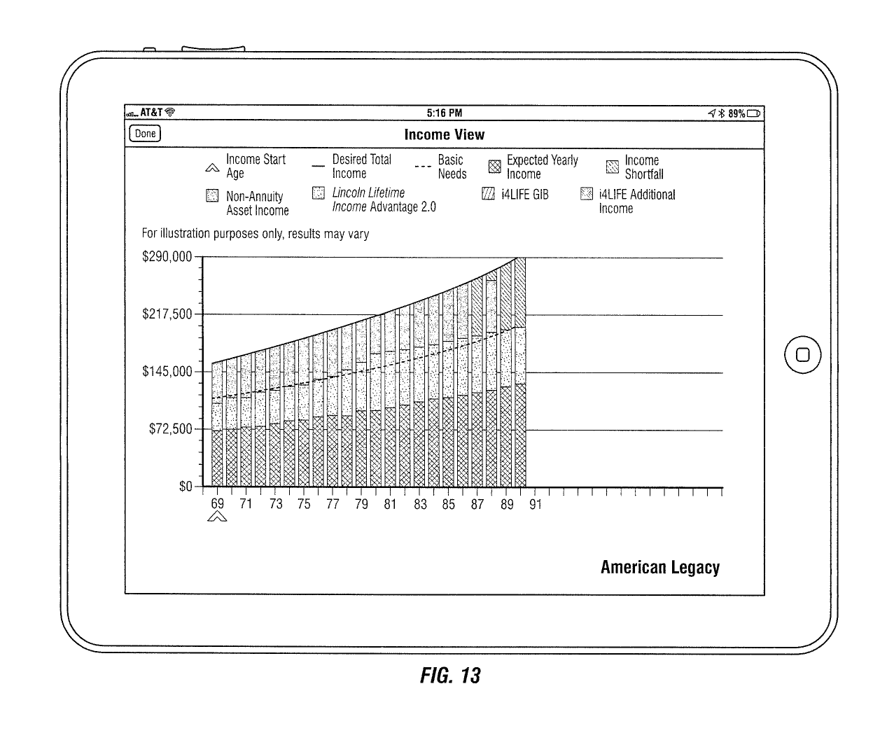

In this example, the user may select between an “Assets” view in which the amount of assets are plotted against the customer's age over a certain time period and an “Income” view (FIG. 6) in which the amount of expected income is plotted against the customer's age of a certain time period. The user can select between these views in this example by selecting either “Assets” or “Income.” An enlarged version of these graphs could be displayed by selecting the expanded view icon (FIG. 13). Instead of a graphical visualization of the data, the user could select a table or chart view by selecting the “Data View” (FIG. 12) in this example. Preferably, the initial annuity investment amount parameter is set to zero, as shown in FIG. 5, so the customer can see the retirement plan without the influence of any annuity products that are being offered for sale.

FIG. 6 shows the example interface with the same customer profile set to the “Income” view. As discussed above, the initial annuity investment amount parameter defaults to zero to show a retirement plan without the annuity products offered for sale. From the “Income” view, the customer can easily see a shortfall in income after a period of years. In this example, the graphical representation of the “Income Shortfall” is shown with different indicia, such as a different color, to highlight the potential problem for the ease of the customer.

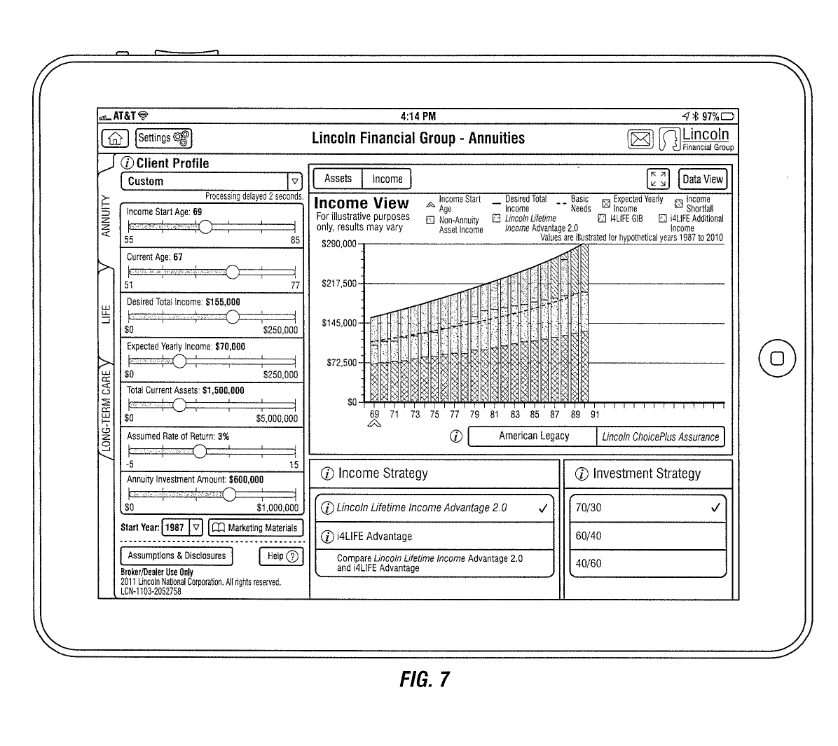

FIG. 7 shows the example interface of FIG. 6, but with the annuity investment amount set to $600,000. In this example, the user has selected a specific annuity product (which is labeled as “Lincoln Lifetime Income Advantage 2.0” in this example) on which to base the possible income shown on actual historical data. This additional annuity income is shown visually in different indicia than the income shortfall so the customer can see the annuity income replacing the income shortfall. From this example depiction, the customer can easily see the positive impact of the annuity product on income shortfall, even though an income shortfall remains.

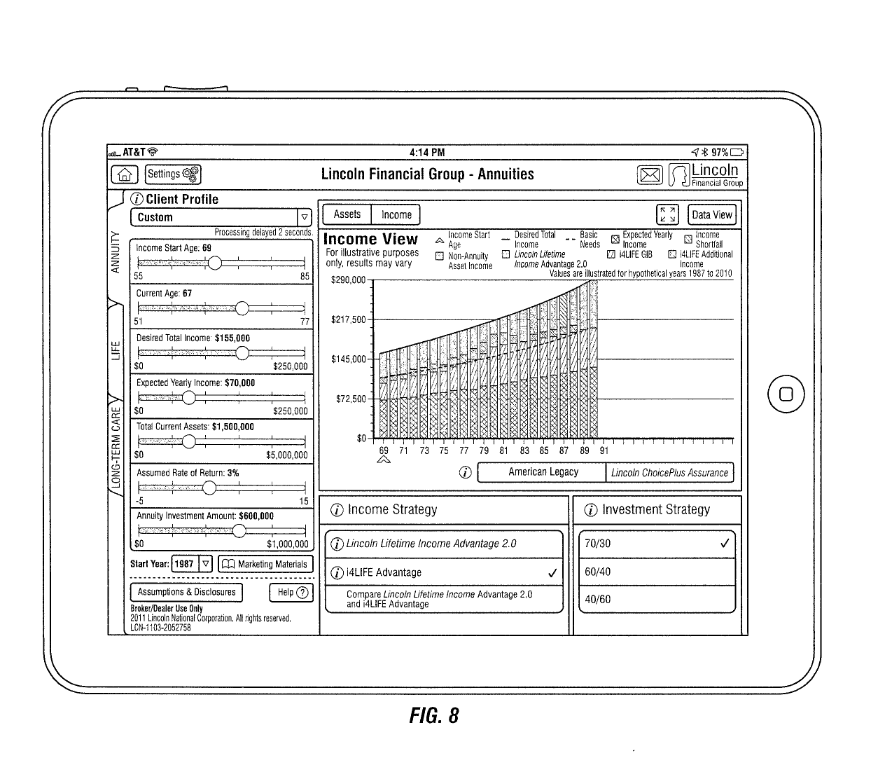

FIG. 8 shows the example interface of FIG. 7, but in this example the user has chosen a different annuity product labeled “i4Life Advantage.” As can be seen from this example, the income shortfall has been totally eliminated by switching from the first product selection of FIG. 7 and the second product selection of FIG. 8. From the graphical representation, the customer can easily see the impact of one product compared to another product as to possible retirement income. Although the example in these screenshots only shows two different products, embodiments are contemplated in which more than two products may be shown. This example shows products offered from the same company, but embodiments are contemplated in which a competitor's products could be modeled based on historical data and compared in a visual representation.

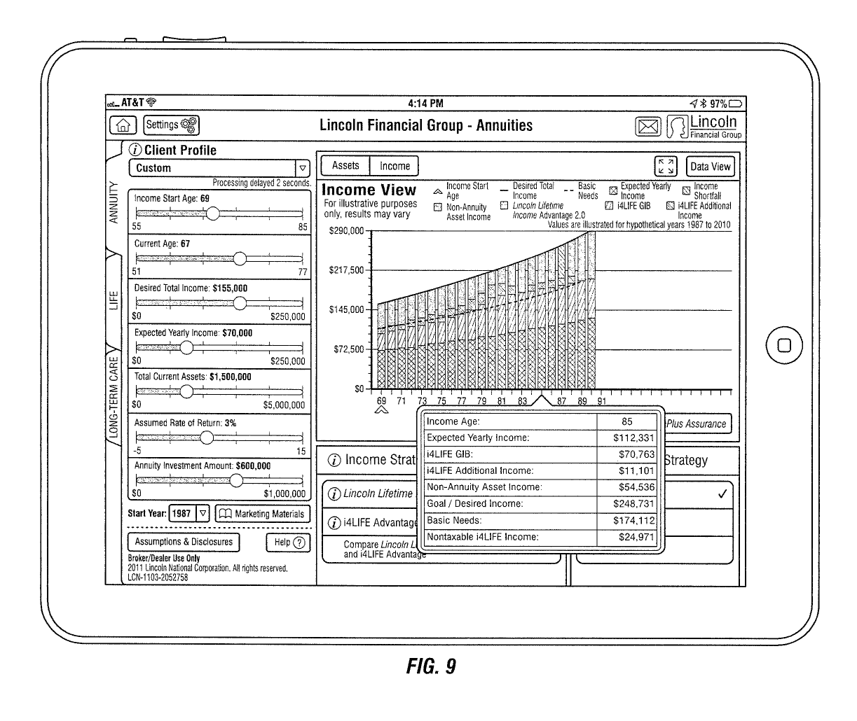

FIG. 9 shows an example feature in which the user can obtain detailed information about data in the graph by selecting a specific year in the retirement plan. On a touch screen, for example, the user may touch the portion of the graph that is of interest. If a mouse is used, by way of another example, the detailed information may be displayed when the “cursor” hovers over various areas of the graph.

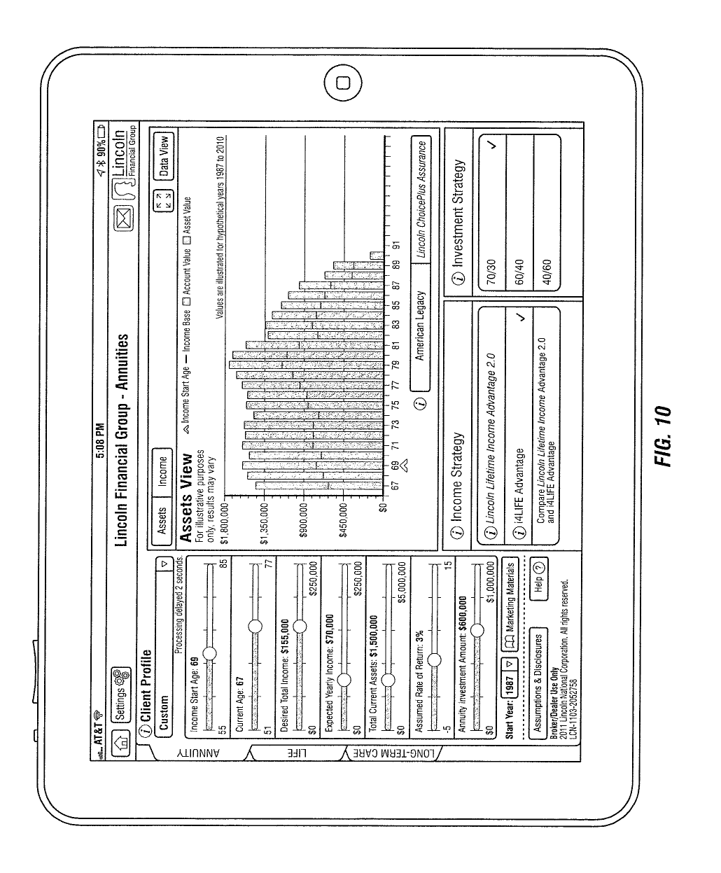

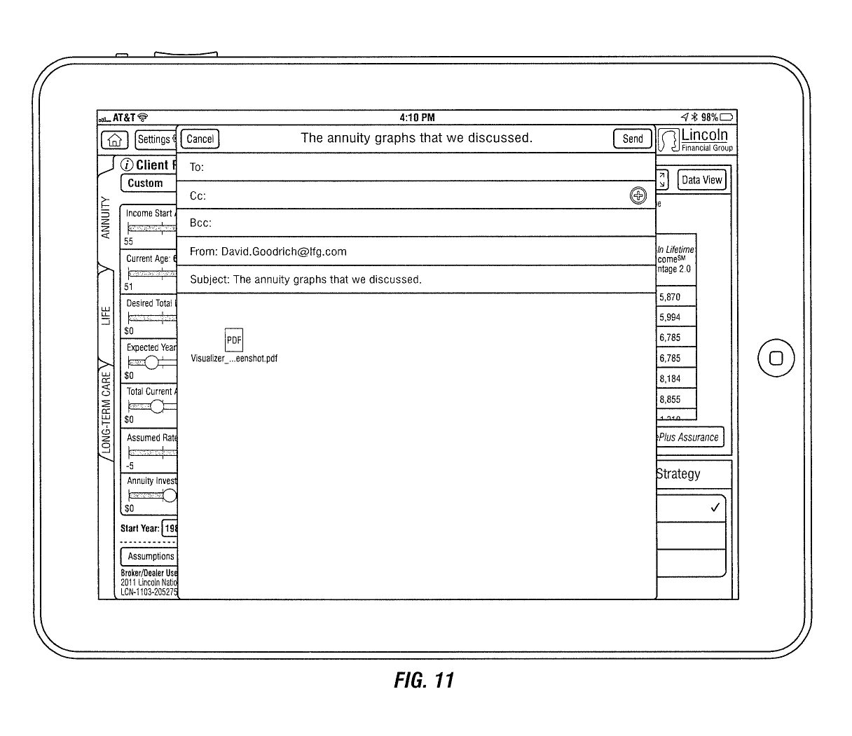

FIG. 10 shows the example interface shown in FIG. 8 in the “Assets” view. In this view, an “envelope” icon can be seen, which is configured to take a screen shot of the interface and launch an email program. FIG. 11 shows the example email program that can be launched by selecting the “envelope” icon with an attachment file with the screen shot of the interface. This allows a financial wholesaler or advisor to quickly send screenshots of different scenarios to an advisor or client.

FIGS. 14-21 show documents, including text and multimedia which can be accessed using the example interface.

FIGS. 22-29 show an embodiment of the sales tool for visualizing aspects of a long term care policy according to one embodiment.

Although the present invention has been described with reference to particular means, materials and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A computerized system comprising:
a customer profile calibration module on a computer configured to allow selection of one or more customer parameters;
a product selection module on a computer configured to allow selection of a financial product; and
a visualization module on a computer configured to graphically display an impact of the selected financial product on one or more of the selected customer parameters based on actual historical data over a specified time period.

2. The computerized system of claim 1, wherein the customer profile calibration module is further configured to allow an adjustment of the one or more selected customer parameters and the specified time period.

3. The computerized system of claim 2, wherein the visualization module is configured to automatically display an adjusted impact of the selected financial product on the one or more selected customer parameters, based on one or more adjusted customer parameters.

4. The computerized system of claim 3, wherein the visualization module is configured to automatically display the adjusted impact based on an adjusted time period.

5. The computerized system of claim 1, wherein the customer profile calibration module is further configured to allow creation of a customer profile that includes one or more customer parameters.

6. The computerized system of claim 1, wherein the customer profile calibration module is further configured to allow selection of a predetermined customer profile that includes one or more preset customer parameters.

7. The computerized system of claim 1, wherein the financial product comprises an annuity.

8. The computerized system of claim 1, wherein the financial product comprises long term care insurance.

9. The computerized system of claim 1, wherein the financial product comprises life insurance.

10. The computerized system of claim 1, further comprising a documentation module configured to allow selection of documentation associated with the financial product.

11. The computerized system of claim 10, wherein the documentation module is further configured to send the selected documentation to an electronic mail address.

12. The computerized system of claim 1, wherein one of the one or more customer parameters comprises an initial investment amount.

13. The computerized system of claim 1, wherein the one or more customer parameters comprises a current age and an income start age.

14. A computerized system comprising:
one or more computing devices including:
a memory having program code stored therein;
a processor in communication with the memory for carrying out instructions in accordance with the stored program code, wherein the program code, when executed by the processor, causes the processor to perform operations comprising:
allowing selection of one or more customer parameters;
allowing selection of a financial product; and
graphically displaying an impact of the selected financial product on the one or more selected customer parameters based on actual historical data over a specified time period.

15. The computerized system of claim 14, wherein the operations further comprise allowing an adjustment of the one or more selected customer parameters and the specified time period.

16. The computerized system of claim 15, wherein the operations further comprise automatically displaying an adjusted impact of the selected financial product on the one or more selected customer parameters, based on one or more adjusted customer parameters.

17. The computerized system of claim 16, wherein the operations further comprise automatically displaying the adjusted impact based on an adjusted specified time period.

18. The computerized system of claim 14, wherein the operations further comprise automatically displaying an impact of the selected financial product on an adjusted specified time period.

19. The computerized system of claim 14, wherein the operations further comprise allowing creation of a customer profile that includes one or more customer parameters.

20. The computerized system of claim 14, wherein the operations further comprise allowing selection of a predetermined customer profile that includes one or more preset customer parameters.

21. The computerized system of claim 14, wherein the financial product comprises an annuity.

22. The computerized system of claim 14, wherein the operations further comprise allowing selection of documentation associated with the selected financial product.

23. The computerized system of claim 22, wherein the operations further comprise sending the selected documentation to an electronic mail address.

24. The computerized system of claim 14, wherein at least one of the one or more computing devices comprises a mobile device.

25. A computerized system comprising:
a customer profile calibration module on a computer configured to:
allow selection of one or more customer parameters;
allow an adjustment of the one or more selected customer parameters and a specified time period;
a product selection module on a computer configured to allow selection of a financial product; and
a visualization module on a computer configured to automatically graphically display an adjusted impact of the selected financial product on the one or more selected customer parameters, based on actual historical data of the specified time period, and in accordance with an adjusted one or more customer parameters.

26. The computerized system of claim 25, wherein the visualization module is configured to automatically display the adjusted impact based on an adjusted time period.

27. The computerized system of claim 25, wherein the customer profile calibration module is further configured to allow creation of a customer profile that includes one or more customer parameters.

28. The computerized system of claim 25, wherein the customer profile calibration module is further configured to allow selection of a predetermined customer profile that includes one or more preset customer parameters.

29. The computerized system of claim 25, wherein the financial product comprises an annuity.

30. The computerized system of claim 25, wherein the financial product comprises long term care insurance.

31. The computerized system of claim 25, wherein the financial product comprises life insurance.

32. The computerized system of claim 25, further comprising a documentation module configured to allow selection of documentation associated with the financial product

33. The computerized system of claim 32, wherein the documentation module is further configured to send the selected documentation to an electronic mail address.

34. A computerized system comprising:
one or more computing devices including:
a memory having program code stored therein;
a processor in communication with the memory for carrying out instructions in accordance with the stored program code, wherein the program code, when executed by the processor, causes the processor to perform operations comprising:
allowing selection of one or more customer parameters;
allowing an adjustment of the one or more selected customer parameters and a specified time period;
allowing selection of a financial product; and
automatically graphically displaying an adjusted impact of the selected financial product on the one or more selected customer parameters, based on actual historical data of the specified time period, and in accordance with one or more adjusted customer parameters.

35. The computerized system of claim 34, wherein the operations further comprise automatically displaying the adjusted impact based on an adjusted time period.

36. The computerized system of claim 34, wherein the operations further comprise allowing creation of a customer profile that includes one or more customer parameters.

37. The computerized system of claim 34, wherein the operations further comprise allowing selection of a predetermined customer profile that includes one or more preset customer parameters.

38. The computerized system of claim 34, wherein the financial product comprises an annuity.

39. The computerized system of claim 34, wherein the operations further comprise allowing selection of documentation associated with the selected financial product

40. The computerized system of claim 39, wherein the operations further comprise sending the selected documentation to an electronic mail address.

41. The computerized system of claim 34, wherein at least one of the one or more computing devices comprises a mobile device.

42. A computerized system comprising:
a processor;
a memory having machine-executable code stored thereon that causes the processor to:
generate a user interface on a touch screen display, wherein the user interface includes:
a plurality of profile interface elements, wherein each of the plurality of profile interface elements is associated with a respective profile parameter; and
at least one product interface element associated with a financial product;
receive a selection of one of the plurality of profile interface elements to select the respective profile parameter;
receive a selection of the at least one product interface element to select the financial product; and
in response to a user selecting an interface element, graphically display an impact of the selected financial product on the plurality of customer profile parameters based on actual historical data over a specified time period.

43. The computerized system of claim 42, wherein the user interface includes a time period interface element associated with the specified time period; and the code further causes the processor to allow an adjustment of the specified time period by selection of the time period interface element.

44. The computerized system of claim 43, wherein the code further causes the processor to automatically display an adjusted impact of the selected financial product on the one or more selected customer profile parameters, based on one or more adjusted profile parameters.

45. The computerized system of claim 44, wherein the code further causes the processor to automatically display the adjusted impact based on an adjusted specified time period.

46. The computerized system of claim 42, wherein the code further causes the processor to allow creation of a customer profile that includes one or more profile parameters.

47. The computerized system of claim 42, wherein the code further causes the processor to allow selection of a predetermined customer profile that includes one or more preset customer profile parameters.
